(19) United States
(12) Patent Application Publication
(10) Pub. No.: US 2004/0052719 A1
(43) Pub. Date: Mar. 18, 2004

(54) Preparation of non corrosive aluminum sulfate

(76) Inventors: Benjamin Shultes III, Liverpool, NY (US); Karen E. Ruehl, Ballwin, MO (US)

Correspondence Address: Arthur J. Plantamura, General Chemical Corp, 90 E Halsey Rd, Parsippany, NJ, 07054, US

(21) Appl. No.: 10/244,692

(22) Filed: Sep. 16, 2002

(51) Int. Cl. C01F 7/74

(52) U.S. Cl. 423/556

(57) ABSTRACT

The addition of an alkali, preferably hydrated lime to aluminum sulfate raises the pH, increases that cationic charge, improves performance as compared to aluminum sulfate alone and causes the aluminum sulfate to be non-corrosive to skin and metal. The addition of a minor quantity of phosphoric acid also provides added stability to the product.

The advantages of this modified alum include improved floc performance over standard alum and other polyaluminum chloride (PACl) products. Therefore, the product of the invention (by varying the percent of lime to alum) has the potential to compete with polyaluminum chloride products using alum-based products. These polyaluminum sulfate products do not decrease the pH of treated water, as much as alum and performs more like a PACl product. The polyaluminum sulfate (PAS), like the PACl works well in low alkalinity waters. The PAS products have been found to remove total organic carbon and lower turbidity very efficiently.

This invention relates to a relatively non-hazardous aluminum sulfate which is substantially less corrosive than the conventional or standard commercial product. More particularly the invention comprises the provision of aluminum sulfate that is processed via the addition of an alkali such as lime to liquid aluminum sulfate to raise the pH and to thereby increase the cationic charge and improve the performance of alum. The processed aluminum sulfate made by the herein described process produces a relatively more efficient polyaluminum sulfate commercial product.

### BACKGROUND OF THE INVENTION

Aluminum sulfate is derived commercially by the reaction of bauxite or kaolin clay with sulfuric acid (30-60%) generally by the use of raw materials that are naturally low in iron and potassium to avoid the difficult removal of iron. The iron-free grade (<0.005% Fe₂O₃ max) is produced by using pure alumina trihydrate, Al₂O₃3H₂O, in place of the bauxite or clay. A major use of aluminum sulfate or alum occurs in the paper industry wherein it is used to clarify process waters and to control the pH of pulp slurries. Another important use is in the treatment of potable water and for processing waste waters. Aluminum sulfate has other major uses as well, including for example the manufacture of soaps, chemicals, pharmaceuticals, greases, fire-extinguishing solutions, tanning foods and modifying concrete.

The maximum commercial concentration of the aluminum sulfate (alum) produced is about 48.5% by weight and at this concentration and even at substantially lower concentrations, alum poses a significant hazard. In particular, as federal, state and local requirements for water purity become more stringent, the level of environmental concerns increases so that means of purifying water that reaches ground, rivers and lakes to higher levels continue to be sought. Aluminum sulfate (alum) solutions is not exempt from these concerns.

Accordingly, a means for the production of a less toxic commercial alum that significantly lessen the hazards posed by this widely used product is of substantial benefit.

### SUMMARY OF THE INVENTION

A present process for manufacturing aluminum sulfate or other aluminum-bearing ores is to digest bauxite ores containing hydrated aluminum (Al₂O₃3H₂O) with sulfuric acid. The maximum commercial concentration of the aluminum sulfate (alum) produced is about 48.5% by weight a concentration that poses a substantially environmental consideration. In accordance with the invention we have discovered that by the addition of an alkali preferably lime to the liquid aluminum sulfate in the course of manufacture, a substantially superior product is obtained; by the addition of the alkali, the pH is raised substantially, the cationic charge increases and the performance of the alum produced, i.e. the polyaluminum sulfate product, is improved; and, most importantly, the aluminum sulfate is rendered less corrosive to the skin as well as to metal. We have found also that, that the addition of a minor amount of phosphoric acid aids the process.

### DETAILED DESCRIPTION OF THE INVENTION

One process for manufacturing aluminum sulfate is to digest bauxite ores containing hydrated alumina (Al₂O₃3H₂O) use in lieu thereof, aluminum trihydrates with sulfuric acid. The maximum commercial concentration of the aluminum sulfate (alum) produced is about 48.5% by weight. During the process some of the alum residue created during manufacture is entrained with some of the wash water and transferred to containment ponds. This water will then percolate into the soil, carrying with it aluminum and sulfate ions in measurable amounts, unless they are removed from the wash waters first. In order to meet, and preferably to exceed, the minimum levels set by various federal and state standards for drinking water prior to disposal of such water into the public waterways, these ions must be removed from the entrained water. In the manufacturing process it is apparent that even the process for aluminum contain about 56 ppm of iron, 18,400 ppm of sulfate and 2900 ppm of aluminum, and thus these solutions must be purified before they can be discharged into the public waters. Further, the pH of between 6.5-8.5. Thus the waste solution must also be treated, as with an alkali, to increase the pH to within the designated range. It is apparent therefore that the production of a less corrosive alum not only results in a beneficial product but also alleviates much of the waste water problem associated with alum manufacture.

Various levels of hydrated lime has been added to the standard aluminum sulfate to produce a product that is non-corrosive to skin and to aluminum and carbon steel metals. By varying the amount of lime added to aluminum sulfate (usually 05 to 20 weight percent) a new product is produced. The new product is referred to herein as polyaluminum sulfate (PAS). This polyaluminum sulfate has a higher pH, improved stability and a higher cationic charge which causes the basicity to increase and, thus, causes improved performance. Additionally, 05 to 5% phosphoric acid can be added to the alum lime-mixture to significantly improve stability and floc formation, thus, improving performance.

The advantages of the process of the invention are to improve floc performance over standard alum and other inorganic coagulants, and to make the product non-corrosive to skin and metal.

These products (by varying the percent of alkali to alum) have the potential to compete with polyaluminum chloride (PACl) products using alum-based products and thereby afford a significant competitive edge.

Process involves the addition of various different weight percents of the alkali; such as rotary hydrated lime (of the kind that is available from Mississippi Lime) to the alum and mixed for 2 hrs or until all of the lime and other base additive has dissolved. The lime, or a portion thereof, may be substituted with another base additive such as soda ash, caustic soda, hydrated lime, and the like. The solution is then filtered using a #41 filter paper to remove any insoluble materials. The procedure obtained is a 5-50% basic polyaluminum sulfate product of superior stability, performance, and non-corrosive to skin and metal.

The inventions will be described in greater detail by reference to the following examples. However the invention is not to be considered as limited by the details presented therein.

General Procedure

An alum corrosion study was conducted to determine if alum could be labeled as non-corrosive material by altering its characteristics slightly, yet still meet all federal DOT regulations for shipment purposes. The test was conducted for a two week period under two temperature conditions: one at room temperature, the other at 130 F.

Corrosion rates were determined on three metals: carbon steel (Cl020), aluminum metal (AL7075) and stainless steel (316L). As per the specifications in the code of federal regulations, 49 CFR 173.137, if the corrosion rate exceeds 6.25 mm (0.25 inches yr., 250 mil/yr), then it is considered corrosive.

Corrosion rates were determined as follows:

$$Corrosion rate = \frac{weight difference \times 534000}{Metal Density \times Metal Area \times Time Exposure ( hr )}$$

Metal densities for C1020 is 7.87 gm/cm3; AL7075 is 2.80 gm/cm3; 316L is 7.98 gm/cm3.

Metal area is 3.38 sq. inches.

Time exposure is 336 hours.

Plugging in the numbers will give the corrosion rate in mils/yr. As long as the corrosion rate does not exceed 250 mils/yr. based on a test temperature of 130 F, the alum can be regarded and shipped as non-corrosive. All testing done was based on Federal testing procedures and standards.

To produce alum as a non-corrosive material, it was necessary to modify the alum slightly by adding lime to produce a higher pH and positively charged product. Mixtures from 1 to 10% lime was added to the alum. From the attached chart it can be seen that there was one failure (Cl020 at 130 F) which did not pass the corrosion rate test (264.8 Vs 250 mil/yr. Max). This sample contained a relatively low amount of lime, i.e. 1% lime mixed with alum. To make the material non-corrosive, which may be affected by the particular chemical composition of the alum, it may be necessary to increase the lime level to achieve a corrosion rate below 250 mil/yr. The aluminum and 316 stainless steel coupons passed all corrosivity rate testing at both testing temperatures. It is apparent from this testing, that corrosivity levels can be controlled by the amount of lime added

While the addition of lime to control corrosivity introduces a slight increase in cost to produce the product of the invention, the benefits far outweigh the cost. Alum can now be produced as two different products; corrosive vs. non-corrosive. The non-corrosive alum comprising the polyaluminum sulfate of the present invention: the testing of the alum prepared according to the invention, was done according to government testing procedures with an adjustment for corrosivity rates by varying the levels of lime to keep within federal guidelines for shipping.

As seen by reference to the data in Tables I

TABLE I
SAMPLES: Alum mixed with Lime (1%-A, 3%-B, 5%-C, 10%-D)
Jan. 25, 2002

| SAMPLE | % Al₂O₃ | % Basicity | Specific Gravity | pH |
|---|---|---|---|---|
| Lime 1% | 8.35 | 6.61 | 1.321 | 2.37 |
| STC #9759 | | | | |
| Lime 3% | 8.39 | 10.0 | 1.307 | 2.54 |
| STC #9760 | | | | |
| Lime 5% | 8.35 | 23.6 | 1.267 | 2.83 |
| STC #9761 | | | | |
| Lime 10% | 8.41 | 40.4 | 1.219 | 3.18 |
| STC #9762 | | | | |

TABLE II
PACKING GROUP ASSIGNMENT TABLE

| | CORROSITEX Time (in Minutes) | | | |
|---|---|---|---|---|
| Category | 0 to 3 min. | >3 to 60 min. | >60 to 240 min. | >240 min. |
| 1 | | | | |
| Category | 0 to 3 min. | >3 to 330 min. | >30 to 60 min. | >60 min. |
| 2 | | | | |
| | ↓ | ↓ | ↓ | ↓ |
| | Packing | Packing | Packing | Non- |
| | Group I | Group II | Group III | Corrosive |

Although the invention has been described in terms of particular embodiments, blends of one or more of the various additives described herein can be used, and substitutes therefor, as will be known to those skilled in the art. Thus the invention is not meant to be limited to the details described herein, but only by the scope of the appended claims.

What is claimed:

1. A method for the manufacture of a relatively non-corrosive aluminum sulfate which comprise
(a) introducing and mixing an alkali into a solution of aluminum sulfate having a concentration of between about 82% to 97% by weight and in sufficient amounts and such that when the alkali is substantially dissolved, the pH of the solution yields a polyaluminum sulfate product having an elevated cationic changes of at least 5, and
(b) filtering the polyaluminum sulfate reaction product.

2. The method of claim 1 wherein the quantity of alkali introduced and mixed into the aluminum sulfate solution comprises from about 3% to about 12% by weight of the aluminum sulfate.

3. The method of claim 1 wherein the alkali is lime.

4. The method of claim 1 wherein the lime is hydrated lime.

5. The method of claim 1 wherein the solution of aluminum sulfate has a concentration of between about 86% to about 90% by weight and the alkali comprises between about 3% to 12% by weight.

6. The method of claim 5 in which the alkali is lime and wherein about 0.5% phosphoric acid is added.

7. The method of claim 6 in which the lime is hydrated lime and wherein 1.5% to about 3% phosphoric acid is added.

8. A relatively non-corrosive aluminum sulfate product comprising the reaction product of between about 88% to about 97% by weight of aluminum sulfate and between about 3% and about 12% by weight of an alkali.

9. The product of claim 8 in which the alkali is lime.

10. The product of claim 8 in which the alkali is hydrated lime.

11. The product of claim 10 in which the reaction product incorporates from about 0.5% to about 5% by weight of phosphoric acid.
